(19) United States
(12) Patent Application Publication
(10) Pub. No.: US 2026/0116202 A1
(43) Pub. Date: Apr. 30, 2026

(54) VEHICLE CONTROL APPARATUS AND METHOD FOR BIDIRECTIONAL CHARGING AND DISCHARGING OF BATTERY

(71) Applicants: Hyundai Motor Company, Seoul (KR); Kia Corporation, Seoul (KR)

(72) Inventors: Jae Heun Kim, Hwaseong (KR); Hee Chang Oh, Hwaseong (KR); Ki Seon Sim, Hwaseong (KR)

(21) Appl. No.: 18/959,424

(22) Filed: Nov. 25, 2024

(30) Foreign Application Priority Data
Apr. 19, 2024 (KR) 10-2024-0052917

(51) Int. Cl. B60L 3/12; B60K 35/22; B60K 35/28; B60L 1/00; B60L 15/40; B60L 53/00; B60Q 9/00

(52) U.S. Cl. CPC B60L 3/12; B60K 35/22; B60K 35/28; B60L 1/00; B60L 15/40; B60L 53/00; B60Q 9/00; B60K 2360/166; B60K 2360/169; B60L 2240/54; B60L 2240/60; B60L 2250/00

(57) ABSTRACT

A vehicle control apparatus includes a memory and a processor. The processor charges a battery used to drive a vehicle by charging or discharging, based on charge power, determines a route based on at least one location included in locations which are not medical facilities, but need to use medical equipment, determines an amount of power necessary to drive the vehicle along the route and use the medical equipment, provides use of the medical equipment at the at least one location or provides a user with a notification indicating that it is impossible to use the medical equipment at the at least one location, and delivers insufficiency of the charging remaining capacity or not to a control room which handles a situation causing the vehicle or a vehicle including medical equipment and different from the vehicle to reach at least one specified location.

### CROSS-REFERENCE TO RELATED APPLICATION

This application claims under 35 U.S.C. § 119(a) the benefit of Korean Patent Application No. 10-2024-0052917, filed in the Korean Intellectual Property Office on Apr. 19, 2024, the entire contents of which are incorporated herein by reference.

### BACKGROUND

### (a) Technical Field

The present disclosure relates to a vehicle control apparatus and method for bidirectional charging and discharging of a battery, more particularly, to technologies for supplying power to an electronic device via a vehicle.

### (b) Description of the Related Art

With the development of battery technology, a vehicle may be charged with electric energy by a battery included in the vehicle from an external power source and may use the charged electric energy to drive. Particularly, the vehicle capable of charging or operating an electronic device by the electric energy stored in the battery may improve user convenience by bidirectional power conversion.

### SUMMARY

An aspect of the present disclosure provides a vehicle control apparatus and method for bidirectional charging and discharging of a battery of a vehicle, including for supplying power from the vehicle to operate medical equipment.

An aspect of the present disclosure provides a vehicle control apparatus for operating medical equipment by power supplied from a vehicle at locations which need to use the medical equipment to improve user convenience and a method thereof.

An aspect of the present disclosure provides a vehicle control apparatus for selecting a route between locations which need to use medical equipment and monitoring a charging remaining capacity of the battery to handle a situation causing a vehicle to reach the locations and a method thereof.

An aspect of the present disclosure provides a vehicle control apparatus for operating medical equipment by power supplied by a vehicle to provide a patient in a remote place from a medical team with a medical service and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus may include a memory storing at least one instruction and a processor that executes the at least one instruction.

According to an embodiment, the processor may charge a battery used to drive a vehicle by charging or discharging, based on charge power supplied from an external power source, may determine a route based on at least one location included in locations for using medical equipment, may determine an amount of power necessary to drive the vehicle along the route and use the medical equipment, and may provide use of the medical equipment at the at least one location, based on the amount of power and a charging remaining capacity of the battery or may provide a user with a notification indicating that it is impossible to use the medical equipment at the at least one location. In addition, the processor may deliver insufficiency of the charging remaining capacity or not to a control room which handles a situation causing the vehicle or a vehicle including medical equipment and different from the vehicle to reach at least one specified location among the locations.

According to an embodiment, the processor may drive the vehicle along the route, based on that the amount of power is smaller than or equal to the charging remaining capacity of the battery, and supply power to the medical equipment, based on power supplied by the battery at the at least one location, and may provide the user with a notification indicating that the charging remaining capacity is insufficient to supply power to the medical equipment at the at least one location and may deliver the insufficiency of the charging remaining capacity to the control room, based on that the amount of power is greater than the charging remaining capacity.

According to an embodiment, the processor may provide the user with information about that the charging remaining capacity is insufficient for the vehicle to reach any one location among the at least one location or information about that the charging remaining capacity is insufficient to use the medical equipment after the vehicle reaches the any one location by mean of the notification, if the amount of power is greater than the charging remaining capacity.

According to an embodiment, the processor may receive at least one other location included in the locations which are not the medical facilities, but need to use the medical equipment and is different from the at least one location from the control room, while driving the vehicle along the route, may determine a route different from the route based on the at least one other location, may determine an amount of new power necessary to drive the vehicle along the different route and use the medical equipment, may determine a charging remaining capacity of the battery at a time point when the amount of new power is determined, may drive the vehicle along the different route, based on that the amount of new power is smaller than or equal to the charging remaining capacity at the time point, and may supply power to the medical equipment, based on power supplied by the battery at the at least one location, and may provide the user with a notification indicating that the charging remaining capacity at the time point is insufficient to supply power to the medical equipment at the at least one location, based on that the amount of new power is greater than the charging remaining capacity at the time point.

According to an embodiment, the processor may limit at least one of a function of an air conditioner system or a function of a part associated with ignition on of the vehicle, or any combination thereof, if the charging remaining capacity is less than a first threshold charging remaining capacity and is greater than or equal to a second threshold charging remaining capacity capable of using the medical equipment a specified number of times and smaller than the first threshold charging remaining capacity.

According to an embodiment, the processor may limit at least one of a function of an air conditioner system or a function of a part associated with ignition on of the vehicle, or any combination thereof, if an expected charging remaining capacity of the battery after the vehicle reaches the at least one location is less than a first threshold charging remaining capacity and is greater than or equal to a second threshold charging remaining capacity capable of using the medical equipment a specified number of times and smaller than the first threshold charging remaining capacity, based on an amount of power necessary to drive the vehicle along the route.

According to an embodiment, the processor may deliver insufficiency of the expected charging remaining capacity to the control room, if the expected charging remaining capacity is less than the second threshold charging remaining capacity.

According to an embodiment, the processor may provide the user with a screen for guiding the user via a distance the vehicle is able to reach by power of the charging remaining capacity depending on the number of the at least one location, based on at least one of the charging remaining capacity, an amount of power necessary to drive the vehicle along the route, or an amount of power necessary to use the medical equipment, or any combination thereof.

According to an embodiment, the processor may provide the user with a notification for guiding the user to select whether to deliver the insufficiency of the charging remaining capacity to the control room or whether to drive the vehicle based on the route although the charging remaining capacity is insufficient, based on that the amount of power is greater than the charging remaining capacity.

According to an embodiment, the processor may monitor the amount of power necessary to drive the vehicle and use the medical equipment and the charging remaining capacity, while driving the vehicle along the route, and may provide the user with a notification indicating that the monitored charging remaining capacity is insufficient, based on that the amount of monitored power is greater than the monitored charging remaining capacity.

According to an embodiment, the processor may deliver the insufficiency of the charging remaining capacity to the control room to drive the vehicle different from the vehicle to the location, based on that the amount of power is greater than the charging remaining capacity.

A vehicle may include the above-described vehicle control apparatus.

According to another aspect of the present disclosure, a vehicle control method may include charging a battery used to drive a vehicle by charging or discharging, based on charge power supplied from an external power source, determining a route based on at least one location included in locations for using medical equipment, determining an amount of power necessary to drive the vehicle along the route and use the medical equipment, and providing use of the medical equipment at the at least one location, based on the amount of power and a charging remaining capacity of the battery or providing a user with a notification indicating that it is impossible to use the medical equipment at the at least one location. In addition, the vehicle control method may include delivering insufficiency of the charging remaining capacity or not to a control room which handles a situation causing the vehicle or a vehicle including medical equipment and different from the vehicle to reach at least one specified location among the locations.

According to an embodiment, the providing of the use of the medical equipment at the at least one location, based on the amount of power and the charging remaining capacity of the battery or the providing of the notification indicating that it is impossible to use the medical equipment at the at least one location to the user may include driving the vehicle along the route, based on that the amount of power is smaller than or equal to the charging remaining capacity of the battery, and supplying power to the medical equipment, based on power supplied by the battery at the at least one location, and providing the user with a notification indicating that the charging remaining capacity is insufficient to supply power to the medical equipment at the at least one location, based on that the amount of power is greater than the charging remaining capacity. The delivering of the insufficiency of the charging remaining capacity or not to the control room which handles the situation causing the vehicle or the vehicle including the medical equipment and different from the vehicle to reach the at least one specified location among the locations may include delivering the insufficiency of the charging remaining capacity to the control room, based on that the amount of power is greater than the charging remaining capacity.

According to an embodiment, the providing of the use of the medical equipment at the at least one location, based on the amount of power and the charging remaining capacity of the battery or the providing of the notification indicating that it is impossible to use the medical equipment at the at least one location to the user may include providing the user with information about that the charging remaining capacity is insufficient for the vehicle to reach any one location among the at least one location or information about that the charging remaining capacity is insufficient to use the medical equipment after the vehicle reaches the any one location by mean of the notification, if the amount of power is greater than the charging remaining capacity.

According to an embodiment, the vehicle control method may further include receiving at least one other location included in the locations which are not the medical facilities, but need to use the medical equipment and is different from the at least one location from the control room, while driving the vehicle along the route, determining a route different from the route based on the at least one other location, determining an amount of new power necessary to drive the vehicle along the different route and use the medical equipment, determining a charging remaining capacity of the battery at a time point when the amount of new power is determined, driving the vehicle along the different route, based on that the amount of new power is smaller than or equal to the charging remaining capacity at the time point, and supplying power to the medical equipment, based on power supplied by the battery at the at least one location, providing the user with a notification indicating that the charging remaining capacity at the time point is insufficient to supply power to the medical equipment at the at least one location, based on that the amount of new power is greater than the charging remaining capacity at the time point, and delivering insufficiency of the charging remaining capacity at the time point to the control room.

According to an embodiment, the vehicle control method may further include limiting at least one of a function of an air conditioner system or a function of a part associated with ignition on of the vehicle, or any combination thereof, if the charging remaining capacity is less than a first threshold charging remaining capacity and is greater than or equal to a second threshold charging remaining capacity capable of using the medical equipment a specified number of times and smaller than the first threshold charging remaining capacity.

According to an embodiment, the vehicle control method may further include limiting at least one of a function of an air conditioner system or a function of a part associated with ignition on of the vehicle, or any combination thereof, if an expected charging remaining capacity of the battery after the vehicle reaches the at least one location is less than a first threshold charging remaining capacity and is greater than or equal to a second threshold charging remaining capacity capable of using the medical equipment a specified number of times and smaller than the first threshold charging remaining capacity, based on an amount of power necessary to drive the vehicle along the route.

According to an embodiment, the vehicle control method may further include delivering insufficiency of the expected charging remaining capacity to the control room, if the expected charging remaining capacity is less than the second threshold charging remaining capacity.

According to an embodiment, the vehicle control method may further include providing the user with a screen for guiding the user via a distance the vehicle is able to reach by power of the charging remaining capacity depending on the number of the at least one location, based on at least one of the charging remaining capacity, an amount of power necessary to drive the vehicle along the route, or an amount of power necessary to use the medical equipment, or any combination thereof.

According to an embodiment, the providing of the use of the medical equipment at the at least one location, based on the amount of power and the charging remaining capacity of the battery or the providing of the notification indicating that it is impossible to use the medical equipment at the at least one location to the user may include providing the user with a notification for guiding the user to select whether to deliver the insufficiency of the charging remaining capacity to the control room or whether to drive the vehicle based on the route although the charging remaining capacity is insufficient, based on that the amount of power is greater than the charging remaining capacity.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of a vehicle control apparatus according to an embodiment of the present disclosure;

FIG. 2 illustrates an example of a screen provided by a vehicle control apparatus, in the vehicle control apparatus or a vehicle control method according to an embodiment of the present disclosure;

FIG. 3 illustrates an example of a route including at least one location, in a vehicle control apparatus or a vehicle control method according to an embodiment of the present disclosure;

FIG. 4 illustrates an example of a route different from an existing route determined based on a location transmitted from a control room, in a vehicle control apparatus or a vehicle control method according to an embodiment of the present disclosure;

FIG. 5 illustrates an example of mode switching according to a charging remaining capacity, in a vehicle control apparatus or a vehicle control method according to an embodiment of the present disclosure;

FIG. 6 illustrates another example of mode switching according to a charging remaining capacity, in a vehicle control apparatus or a vehicle control method according to an embodiment of the present disclosure;

FIG. 7 illustrates flow of an operation of a vehicle control apparatus for supplying power to medical equipment at at least one location, in the vehicle control apparatus or a vehicle control method according to an embodiment of the present disclosure;

FIG. 8 illustrates flow of an operation of a vehicle control apparatus for determining a mode according to a charging remaining capacity, in the vehicle control apparatus or a vehicle control method according to an embodiment of the present disclosure;

FIG. 9 illustrates flow of an operation of a vehicle control apparatus for supplying power medical equipment at at least one location based on an amount of power and a charging remaining capacity, in the vehicle control apparatus or a vehicle control method according to an embodiment of the present disclosure; and

FIG. 10 illustrates a computing system associated with a vehicle control apparatus or a vehicle control method according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

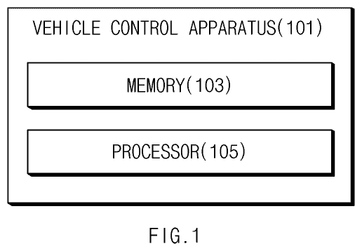

Hereinafter, embodiments of the present disclosure will be described in detail with reference to FIGS. 1 to 10.

FIG. 1 is a block diagram illustrating a configuration of a vehicle control apparatus according to an embodiment of the present disclosure.

A vehicle control apparatus 101 according to an embodiment of the present disclosure may be implemented inside or outside a vehicle, and some of components included in the vehicle control apparatus 101 may be implemented inside or outside the vehicle.

Referring to FIG. 1, the vehicle control apparatus 101 may include at least one of a memory 103 or a processor 105, or any combination thereof. The at least one of the memory 103 or the processor 105, or the any combination thereof may be electronically and/or operably coupled with each other by an electronic component such as a communication bus.

According to an embodiment, hereinafter, that pieces of hardware are operably coupled with each other may mean that a direct connection or an indirect connection between the pieces of hardware is established in a wired or wireless manner, such that second hardware is controlled by first hardware among the pieces of hardware. Types of the pieces of hardware included in the vehicle control apparatus 101 and/or the number of the pieces of hardware are/is limited to those shown in FIG. 1. For example, the vehicle control apparatus 101 may include only some of the hardware components shown in FIG. 1.

According to an embodiment, the memory 103 may store at least one instruction. According to an embodiment, the processor 105 may execute at least one instruction stored in the memory 103.

According to an embodiment, the vehicle control apparatus 101 may charge a battery used to drive the vehicle by charging or discharging based on charge power supplied from an external power source. The battery may be included in the vehicle including the vehicle control apparatus 101. According to an embodiment, the vehicle control apparatus 101 may supply power to an electronic device (e.g., medical equipment loaded into the vehicle) except for the vehicle, based on discharge power supplied by the battery. In other words, the vehicle which is at least one of an electric vehicle (EV), a hydrogen vehicle, or a hybrid electric vehicle, or any combination thereof may facilitate bidirectional power conversion by the battery.

According to an embodiment, the battery may store electric energy for driving the vehicle. In other words, the battery may be charged based on the charge power supplied from the external power source. The battery may supply discharge power to the electronic device except for the vehicle, while being discharged, or may supply the discharge power to drive the vehicle.

According to an embodiment, the processor 105 of the vehicle control apparatus 101 may charge the battery by a power supply or may discharge the battery to supply power to the electronic device except for the vehicle. For example, the electronic device except for the vehicle may include medical equipment which needs power for its operation.

According to an embodiment, the processor 105 of the vehicle control apparatus 101 may control the vehicle to drive to a specific location. For example, the specific location may include a location which is not a medical facility, but needs to use medical equipment.

According to an embodiment, the processor 105 of the vehicle control apparatus 101 may identify a state of a patient by the medical equipment at the specific location or may treat the patient by the medical equipment at the specific location.

According to an embodiment, after controlling the vehicle to drive to the location which is not the medical facility, but needs to use the medical equipment, the processor 105 of the vehicle control apparatus 101 may deliver the state of the patient to a medical team in a remote distance and may output a view of the medical team (e.g., a doctor, a nurse, an emergency worker, an oriental medicine doctor, a midwife, or a dentist), as well as identifying the state of the patient by the medical equipment or treating the patient by the medical equipment, based on power supplied via the battery.

According to an embodiment, the processor 105 of the vehicle control apparatus 101 may determine a route based on at least one specified location among the locations which need to use the medical equipment. The processor 105 of the vehicle control apparatus 101 may drive the vehicle along the determined route and may supply power to the medical equipment at the at least one location to use the medical equipment.

According to an embodiment, while the vehicle is moving to the at least one location, the charging remaining capacity of the battery may be insufficient to reach the at least one location or may be insufficient to use the medical equipment.

According to an embodiment, if the charging remaining capacity of the battery is insufficient to supply power to the medical equipment at the at least one location, the processor 105 of the vehicle control apparatus 101 may not use the medical equipment at the specific location. Therefore, the processor 105 of the vehicle control apparatus 101 may determine an amount of power necessary to drive the vehicle along the route and use the medical equipment and may compare the amount of power with the charging remaining capacity of the battery, thus determining whether it is possible to use the medical equipment at the at least one location.

For example, the processor 105 of the vehicle control apparatus 101 may provide use of the medical equipment at the at least one location, based on that the amount of power necessary is smaller than or equal to the charging remaining capacity of the battery. In other words, the processor 105 of the vehicle control apparatus 101 may drive the vehicle along the route, based on that the amount of power necessary is smaller than or equal to the charging remaining capacity of the battery, and may supply power to the medical equipment, based on power supplied by the battery at the at least one location reached by the driving of the vehicle.

For example, the processor 105 of the vehicle control apparatus 101 may provide a user with a notification indicating that it is impossible to use the medical equipment at the at least one location, based on that the amount of power necessary is greater than the charging remaining capacity of the battery. In other words, the processor 105 of the vehicle control apparatus 101 may deliver insufficiency of the charging remaining capacity or not to a control room which handles a situation causing the vehicle or a vehicle including medical equipment and different from the vehicle is able to reach the at least one specified location among the locations, based on that the amount of power necessary is greater than the charging remaining capacity of the battery.

According to an embodiment, the at least one specified location among the locations which are not medical facilities, but need to use the medical equipment may be plural in number. The processor 105 of the vehicle control apparatus 101 may determine a route capable of passing through all the at least one location. If the at least one location is plural in number, an order of passing through each of the at least one location may be determined by the user of the vehicle control apparatus 101 or the control room, but an embodiment of the present disclosure may not be limited thereto. For example, the processor 105 of the vehicle control apparatus 101 may search for a route, such as searching for a shortest route or a shortest time route, based on the at least one location, which is plural in number, to determine the route.

According to an embodiment, the processor 105 of the vehicle control apparatus 101 may provide the user with a notification indicating that the charging remaining capacity is insufficient to supply power to the medical equipment at the at least one location, based on that the amount of power is greater than the charging remaining capacity. The notification indicating that the charging remaining capacity is insufficient may include information about whether the charging remaining capacity is insufficient for the vehicle to reach any one of the at least one location or information about whether the charging remaining capacity is insufficient to use the medical equipment after the vehicle reaches the any one of the at least one location. The processor 105 of the vehicle control apparatus 101 may provide the user with a notification of guiding the user to select whether to deliver insufficiency of the charging remaining capacity to the control room or whether to drive the vehicle based on the route although the charging remaining capacity is insufficient.

According to an embodiment, while driving the vehicle along the route, the processor 105 of the vehicle control apparatus 101 may monitor the amount of power necessary to drive the vehicle and use the medical equipment and the charging remaining capacity. According to an embodiment, the processor 105 of the vehicle control apparatus 101 may provide the user with a notification indicating that the monitored charging remaining capacity is insufficient, based on that the amount of monitored power is greater than the monitored charging remaining capacity.

According to an embodiment, if the processor 105 of the vehicle control apparatus 101 delivers the insufficiency of the charging remaining capacity to the control room, the control room may deliver the at least one location to the different vehicle to drive the different vehicle to the at least one location.

According to an embodiment, after the vehicle is driven along the route or the driving of the vehicle is ended, the different vehicle may receive at least one other location different from the at least one location of the existing route in a place rather than a garage of the different vehicle from the control room.

According to an embodiment, a processor of a vehicle control apparatus included in the different vehicle may determine whether a charging remaining capacity of a battery is sufficient to drive the vehicle along a different route and use medical equipment.

In other words, the processor of the vehicle control apparatus included in the different vehicle may determine an amount of new power necessary to drive the vehicle along the different route and use the medical equipment and may compare the amount of new power with a charging remaining capacity of the battery at a time point when the amount of new power is determined, thus determine whether it is possible to use the medical equipment at the at least one other location.

According to an embodiment, the processor of the vehicle control apparatus included in the different vehicle may determine a route different from the route before being received from the control room based on the at least one other location.

According to an embodiment, the processor of the vehicle control apparatus included in the different vehicle may determine an amount of new power necessary to drive the vehicle along the different route and use the medical equipment and may determine a charging remaining capacity of the battery at the time point when the amount of new power is determined.

The processor of the vehicle control apparatus included in the different vehicle may drive the vehicle along the different route, based on that the amount of new power is smaller than or equal to the charging remaining capacity at the time point when the amount of new power is determined, and may supply power to the medical equipment, based on power supplied by the battery at the at least one location.

The processor of the vehicle control apparatus included in the different vehicle may provide the user with a notification indicating that the charging remaining capacity at the time point when the amount of new power is determined is insufficient to supply power to the medical equipment at the at least one location and may deliver insufficiency of the charging remaining capacity to the control room, based on that the amount of new power is greater than the charging remaining capacity at the time point when the amount of new power is determined.

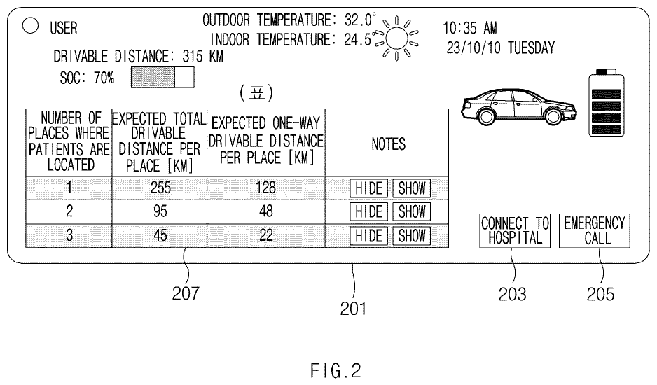

FIG. 2 illustrates an example of a screen provided by a vehicle control apparatus, in the vehicle control apparatus or a vehicle control method according to an embodiment of the present disclosure.

Referring to FIG. 2, a screen 201 may be provided to a user to set a route and guide the user. A first button 203 included in the screen 201 may indicate a button for contacting a control room. A second button 205 included in the screen 201 may indicate a button for notifying the control room of an emergency. A table 207 included in the screen 201 may guide the user via a distance a vehicle is able to reach by power of a charging remaining capacity depending on the number of at least one location.

According to an embodiment, the table 207 may provide the user with the screen 201 for guiding the user via the distance the vehicle is able to reach by the power of the charging remaining capacity depending on the number of the at least one location, based on at least one of a charging remaining capacity of a battery, an amount of power necessary to drive the vehicle along a route, or an amount of power necessary to use medical equipment, or any combination thereof. For example, the table 207 may display the number of the at least one location determined according to the distance the vehicle is able to reach using the power of the charging remaining capacity on the screen 201 to guide the user.

According to an embodiment, if the number of places where patients are located is one, a processor of a vehicle control apparatus may control the vehicle to return to a starting point, only if the charging remaining capacity is greater than or equal to an amount of power necessary for round-trip driving for reaching the location of the place and an amount of power necessary to use medical equipment. Therefore, the processor of the vehicle control apparatus may recommend the user to visit a location within approximately 255 kilometers (km) round trip from the location of the vehicle control apparatus, using a charging remaining capacity of about 70%.

According to an embodiment, if the number of places where patients are located is two, the processor of the vehicle control apparatus may control the vehicle to return to the starting point, only if the charging remaining capacity is greater than or equal to an amount of power necessary for round-trip driving for reaching locations of the two places and an amount of power necessary to use medical equipment after the vehicle reaches the locations. Therefore, the processor of the vehicle control apparatus may recommend the user to visit locations within approximately 95 km round trip from the location of the vehicle control apparatus, using the charging remaining capacity of about 70%.

According to an embodiment, if the number of places where patients are located is three, the processor of the vehicle control apparatus may control the vehicle to return to the starting point, only if the charging remaining capacity is greater than or equal to an amount of power necessary for round-trip driving for reaching locations of the three places and an amount of power necessary to use medical equipment after the vehicle reaches the locations. Therefore, the processor of the vehicle control apparatus may recommend the user to visit locations within approximately 45 km round trip from the location of the vehicle control apparatus, using the charging remaining capacity of about 70%.

According to an embodiment, the table 207 may be referenced when establishing a plan for an order in which the user visits at least one location. If the location is delivered to a control room due to the occurrence of an emergency patient, the table 207 may be referenced to check whether there is a response in real time.

According to an embodiment, the screen 201 may include a button (e.g., a hidden button) capable of hiding contents of the table 207 for visibility. The screen 201 may include a button (e.g., the first button 203) for ease of connection with the control room.

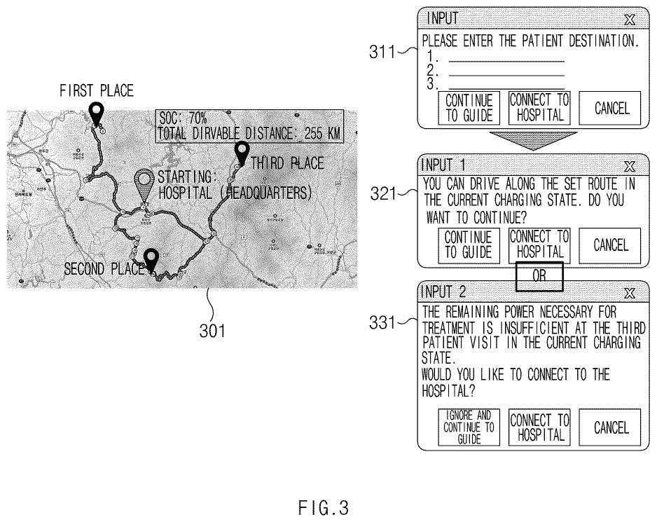

FIG. 3 illustrates an example of a route including at least one location, in a vehicle control apparatus or a vehicle control method according to an embodiment of the present disclosure.

Referring to FIG. 3, a screen 301 may indicate at least one location (e.g., a location in a first place, a location in a second place, and a location in a third place) which is included in locations which are not medical facilities, but need to use medical equipment.

According to an embodiment, a processor of a vehicle control apparatus may determine a route based on the at least one location.

According to an embodiment, the processor of the vehicle control apparatus may obtain the at least one location, by a user input to a first notification 311.

The processor of the vehicle control apparatus may obtain an input of the user to the at least one location by navigation, thus driving a vehicle along the route, based on a current charging remaining capacity (e.g., a state of charge (SOC)), and determining whether it is able to supply power to the medical equipment.

According to an embodiment, the processor of the vehicle control apparatus may start to drive the vehicle along the route to provide use of the medical equipment the at least one location by a user input to a second notification 321.

According to an embodiment, the processor of the vehicle control apparatus may determine whether to deliver insufficiency of the charging remaining capacity to a control room or drive the vehicle based on the route although the charging remaining capacity is insufficient, by a user input to a third notification 331.

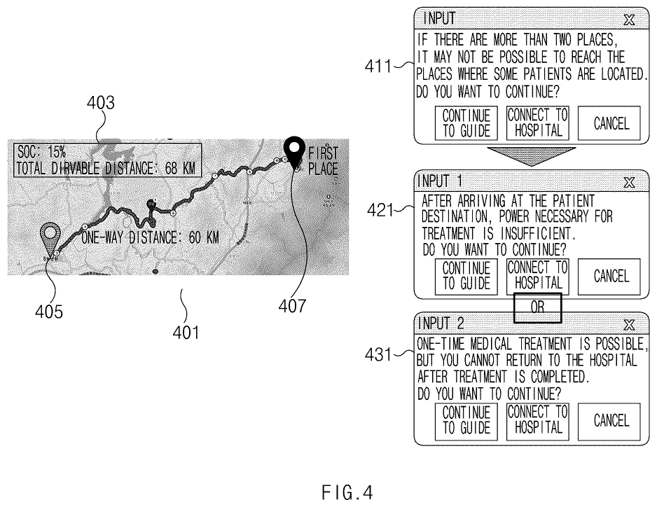

FIG. 4 illustrates an example of a route different from an existing route determined based on a location transmitted from a control room, in a vehicle control apparatus or a vehicle control method according to an embodiment of the present disclosure.

Referring to FIG. 4, a screen 401 may indicate at least one location (e.g., a location in a first place) which is included in locations which are not medical facilities, but need to use medical equipment and is transmitted from a control room, while driving a vehicle along a route. A first location 405 may indicate a location of the vehicle. A second location 407 may indicate at least one location delivered from the control room.

According to an embodiment, a processor of a vehicle control apparatus may determine a route different from an existing route based on at least one other location which is delivered form the control room and is different from the at least one location of the existing route.

According to an embodiment, the processor of the vehicle control apparatus may provide a user with a notification (e.g., a first notification 411) indicating that a charging remaining capacity of a battery is insufficient to reach all of the at least one other location. According to an embodiment, the processor of the vehicle control apparatus may determine whether to deliver insufficiency of the charging remaining capacity to a control room or drive the vehicle based on the route although the charging remaining capacity is insufficient, by a user input to the first notification 411.

According to an embodiment, the processor of the vehicle control apparatus may provide the user with a notification (e.g., the first notification 411) indicating that the charging remaining capacity of the battery is insufficient to reach all the at least one other location. According to an embodiment, the processor of the vehicle control apparatus may determine whether to deliver insufficiency of the charging remaining capacity to the control room or drive the vehicle based on the route although the charging remaining capacity is insufficient, by the user input to the first notification 411.

According to an embodiment, the processor of the vehicle control apparatus may provide the user with a notification (e.g., a second notification 421 or a third notification 431) indicating that the charging remaining capacity of the battery is insufficient to supply power to medical equipment after the vehicle reaches the at least one other location.

According to an embodiment, the processor of the vehicle control apparatus may determine whether to deliver insufficiency of the charging remaining capacity to the control room or drive the vehicle based on the route although the charging remaining capacity is insufficient, by a user input to the second notification 421 or the third notification 431.

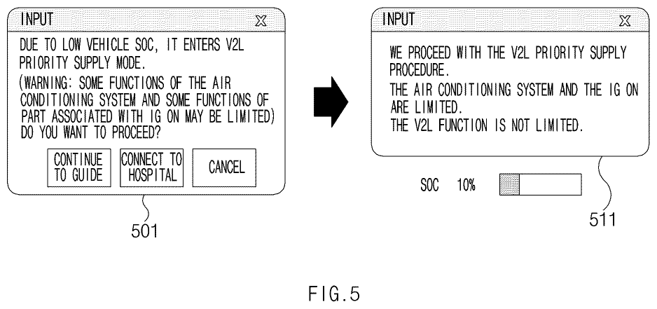

FIG. 5 illustrates an example of mode switching according to a charging remaining capacity, in a vehicle control apparatus or a vehicle control method according to an embodiment of the present disclosure.

Referring to FIG. 5, a first notification 501 may guide a user to enter a user input for mode switching for limiting at least one of a function of an air conditioner system, a function of a part associated with ignition on of a vehicle, or any combination thereof, if a charging remaining capacity of a battery is included in a specified range. A second notification 511 may indicate that the mode switching for limiting the at least one of the function of the air conditioner system or the function of the part associated with the ignition on of the vehicle, or the any combination thereof.

According to an embodiment, if the charging remaining capacity of the battery is less than a first threshold charging remaining capacity and is greater than or equal to a second threshold charging remaining capacity capable of using medical equipment a specified number of times, a processor of the a vehicle control apparatus may limit the at least one of the function of the air conditioner system or the function of the part associated with the ignition on of the vehicle, or the any combination thereof. The processor of the vehicle control apparatus may limit the function of the air conditioner system and the function of the part associated with the ignition on of the vehicle to improve an amount in which the charging remaining capacity is supplied to medical equipment.

The first threshold charging remaining capacity may be greater than the second threshold charging remaining capacity. The second threshold charging remaining capacity may indicate power capable of using the medical equipment a specified number of times (e.g., about one time).

According to an embodiment, if the charging remaining capacity is greater than or equal to a specific threshold charging remaining capacity (e.g., about 2%), the processor of the vehicle control apparatus may supply power to the medical equipment.

According to an embodiment, if the charging remaining capacity is less than the first threshold charging remaining capacity (e.g., about 20%) and is greater than or equal to the second threshold charging remaining capacity (e.g., about 15%), the processor of the vehicle control apparatus may limit the function of the air conditioning system and the function of the part associated with the ignition on of the vehicle to improve the amount in which the charging remaining capacity is supplied to the medical equipment.

According to an embodiment, the processor of the vehicle control apparatus may obtain an expected charging remaining capacity of the battery after the vehicle reaches at least one location, based on an amount of power necessary to drive the vehicle along a route.

According to an embodiment, if the expected charging remaining capacity of the battery is less than the first threshold charging remaining capacity (e.g., about 20%) and is greater than or equal to the second threshold charging remaining capacity (e.g., about 15%), the processor of the vehicle control apparatus may limit the at least one of the function of the air conditioning system or the function of the part associated with the ignition on of the vehicle, or any combination thereof to improve the amount in which the expected charging remaining capacity is supplied to the medical equipment.

The first threshold charging remaining capacity may be greater than the second threshold charging remaining capacity. The second threshold charging remaining capacity may indicate power capable of using the medical equipment a specified number of times (e.g., about one time).

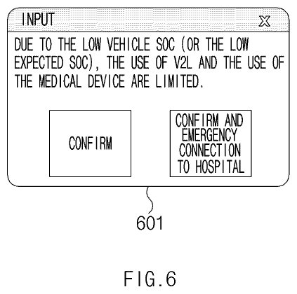

FIG. 6 illustrates another example of mode switching according to a charging remaining capacity, in a vehicle control apparatus or a vehicle control method according to an embodiment of the present disclosure.

Referring to FIG. 6, a first notification 601 may guide a user to enter a user input for determining whether to deliver insufficiency of an expected charging remaining capacity to a control room, if a charging remaining capacity of a battery is included in a specified range.

According to an embodiment, while driving a vehicle along a route, the processor of the vehicle control apparatus may monitor an amount of power necessary to drive a vehicle and use medical equipment and a charging remaining capacity. If it is checked that an expected charging remaining capacity determined based on the amount of monitored power and the monitored charging remaining capacity is less than a second threshold charging remaining capacity (e.g., about 15%), although the vehicle does not reach at least one location, the processor of the vehicle control apparatus may deliver insufficiency of the expected charging remaining capacity to the control room.

According to an embodiment, if it is checked that the expected charging remaining capacity is less than the second threshold charging remaining capacity (e.g., about 15%), although the vehicle does not reach the at least one location, the processor of the vehicle control apparatus may notify the user of a situation by a sound and a notification (e.g., the first notification 601) and may deliver insufficiency of the expected charging remaining capacity to the control room, thus obtaining a user input for whether emergency assistance is required.

According to an embodiment, although the expected charging remaining capacity is greater than or equal to the second threshold charging remaining capacity if the vehicle starts, the expected charging remaining capacity may be less than the second threshold charging remaining capacity while driving by a power consumption situation greater than expected (e.g., a situation in which driving power is more consumed than expected power due to traffic congestion or driving power is more consumed than expected power due to a wrong turn).

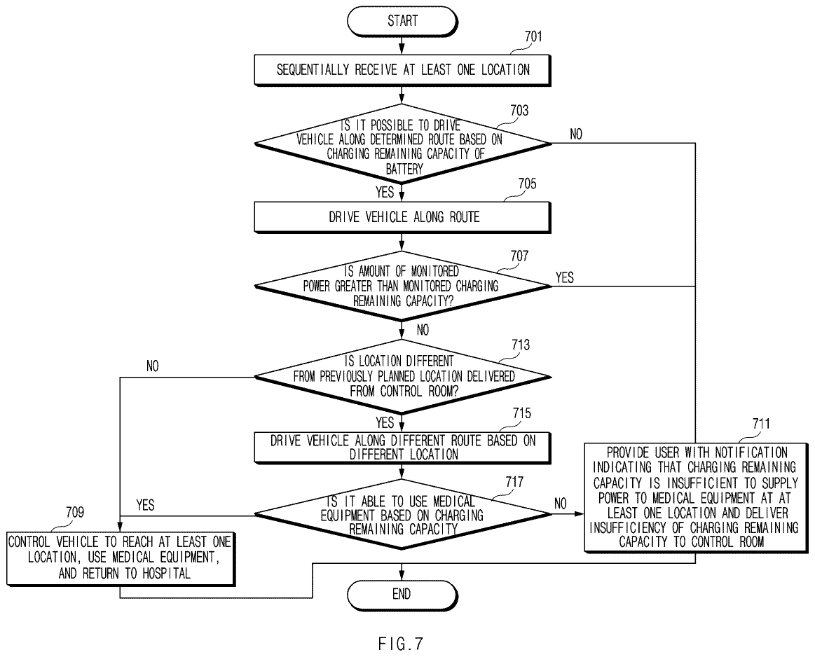

FIG. 7 illustrates flow of an operation of a vehicle control apparatus for supplying power to medical equipment at at least one location, in the vehicle control apparatus or a vehicle control method according to an embodiment of the present disclosure.

Hereinafter, it is assumed that a vehicle control apparatus 101 of FIG. 1 performs a process of FIG. 7. Furthermore, in a description of FIG. 7, an operation described as being performed by a processor of a vehicle control apparatus may be understood as being controlled by a processor 105 of the vehicle control apparatus 101.

Referring to FIG. 7, in first operation 701, the processor of the vehicle control apparatus according to embodiment may sequentially receive at least one location.

According to an embodiment, the at least one location may be included in locations which are not medical facilities, but need to use medical equipment.

In second operation 703, the processor of the vehicle control apparatus according to embodiment may determine whether it is possible to drive a vehicle along a determined route based on a charging remaining capacity of a battery. If it is possible to drive the vehicle along the determined route based on the charging remaining capacity of the battery, the processor of the vehicle control apparatus may perform third operation 705. If it is impossible to drive the vehicle along the determined route based on the charging remaining capacity of the battery, the processor of the vehicle control apparatus may perform fourth operation 711.

In third operation 705, the processor of the vehicle control apparatus according to embodiment may drive the vehicle along the route.

In fourth operation 711, the processor of the vehicle control apparatus according to embodiment may provide a user with a notification indicating that the charging remaining capacity is insufficient to supply power to the medical equipment at the at least one location and may deliver insufficiency of the charging remaining capacity to a control room.

In fifth operation 707, the processor of the vehicle control apparatus according to embodiment may determine whether an amount of monitored power is greater than a monitored charging remaining capacity. If the amount of monitored power is greater than the monitored charging remaining capacity, the processor of the vehicle control apparatus may perform fourth operation 711. If the amount of monitored power is smaller than or equal to the monitored charging remaining capacity, the processor of the vehicle control apparatus may perform sixth operation 713.

In sixth operation 713, the processor of the vehicle control apparatus according to embodiment may determine whether a location different from a previously planned location is delivered from the control room. If the location different from the previously planned location is delivered from the control room, the processor of the vehicle control apparatus may perform seventh operation 715. If the location different from the previously planned location is not delivered from the control room, the processor of the vehicle control apparatus may perform eighth operation 709.

In seventh operation 715, the processor of the vehicle control apparatus according to embodiment may drive the vehicle along the different route based on the different location.

In eighth operation 709, the processor of the vehicle control apparatus according to embodiment may control the vehicle to reach the at least one location, use the medical equipment, and return to the hospital.

In ninth operation 717, the processor of the vehicle control apparatus according to embodiment may determine whether it is able to use the medical equipment based on the charging remaining capacity. If it is able to use the medical equipment based on the charging remaining capacity, the processor of the vehicle control apparatus may perform eighth operation 709. If it is unable to use the medical equipment based on the charging remaining capacity, the processor of the vehicle control apparatus may perform fourth operation 711.

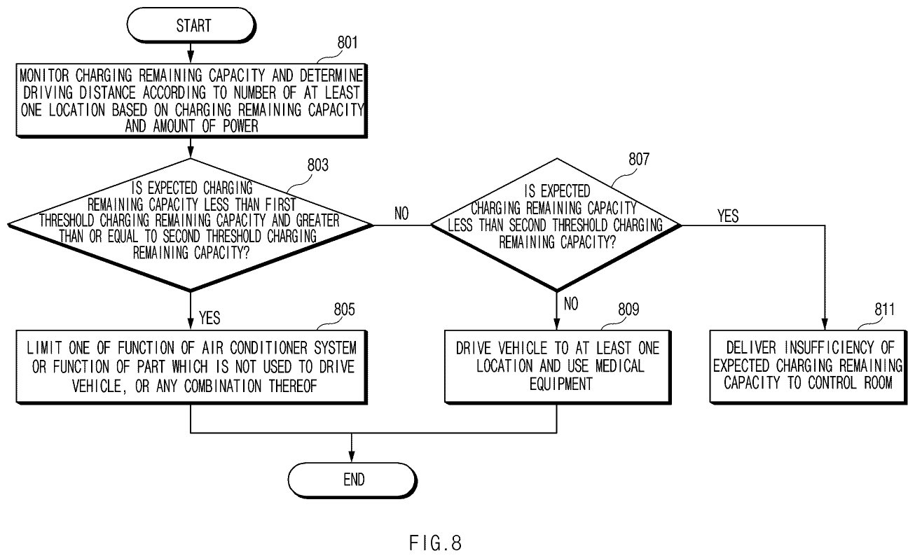

FIG. 8 illustrates flow of an operation of a vehicle control apparatus for determining a mode according to a charging remaining capacity, in the vehicle control apparatus or a vehicle control method according to an embodiment of the present disclosure.

Hereinafter, it is assumed that a vehicle control apparatus 101 of FIG. 1 performs a process of FIG. 8. Furthermore, in a description of FIG. 8, an operation described as being performed by a processor of a vehicle control apparatus may be understood as being controlled by a processor 105 of the vehicle control apparatus 101.

Referring to FIG. 8, in first operation 801, the processor of the vehicle control apparatus according to embodiment may monitor a charging remaining capacity and may determine a driving distance according to the number of at least one location based on the charging remaining capacity and an amount of power.

In second operation 803, the processor of the vehicle control apparatus according to embodiment may identify whether an expected charging remaining capacity is less than a first threshold charging remaining capacity and is greater than or equal to a second threshold charging remaining capacity. If the expected charging remaining capacity is less than the first threshold charging remaining capacity and is greater than or equal to the second threshold charging remaining capacity, the processor of the vehicle control apparatus may perform third operation 805. If the expected charging remaining capacity is greater than or equal to the first threshold charging remaining capacity and is less than the second threshold charging remaining capacity, the processor of the vehicle control apparatus may perform fourth operation 807.

In third operation 805, the processor of the vehicle control apparatus according to embodiment may limit one of a function of an air conditioner system or a function of a part which is not used to drive a vehicle (e.g., a part associated with ignition on of the vehicle), or any combination thereof.

In fourth operation 807, the processor of the vehicle control apparatus according to embodiment may determine whether the expected charging remaining capacity is less than the second threshold charging remaining capacity. If the expected charging remaining capacity is greater than or equal to the second threshold charging remaining capacity, the processor of the vehicle control apparatus may perform fifth operation 809. If the expected charging remaining capacity is less than the second threshold charging remaining capacity, the processor of the vehicle control apparatus may perform sixth operation 811.

In fifth operation 809, the processor of the vehicle control apparatus according to embodiment may drive the vehicle to the at least one location and may use medical equipment.

In sixth operation 811, the processor of the vehicle control apparatus according to embodiment may deliver insufficiency of the expected charging remaining capacity to a control room.

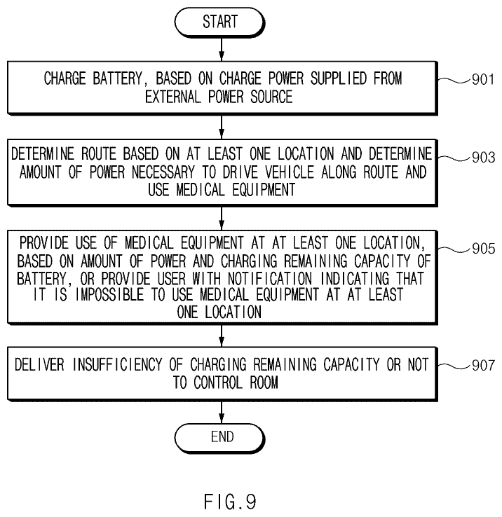

FIG. 9 illustrates flow of an operation of a vehicle control apparatus for supplying power medical equipment at at least one location based on an amount of power and a charging remaining capacity, in the vehicle control apparatus or a vehicle control method according to an embodiment of the present disclosure.

Hereinafter, it is assumed that a vehicle control apparatus 101 of FIG. 1 performs a process of FIG. 9. Furthermore, in a description of FIG. 9, an operation described as being performed by a processor of a vehicle control apparatus may be understood as being controlled by a processor 105 of a vehicle control apparatus 101.

Referring to FIG. 9, in first operation 901, the processor of the vehicle control apparatus according to an embodiment may charge a battery, based on charge power supplied from an external power source.

For example, the battery may be used to drive a vehicle by charging or discharging.

In second operation 903, the processor of the vehicle control apparatus according to embodiment may determine a route based on at least one location and may determine an amount of power necessary to drive the vehicle along the route and use medical equipment.

For example, the at least one location may be included in locations which are not medical facilities, but need to use the medical equipment.

In third operation 905, the processor of the vehicle control apparatus according to embodiment may provide use of the medical equipment at the at least one location, based on the amount of power and the charging remaining capacity of the battery, or may provide a user with a notification indicating that it is impossible to use the medical equipment at the at least one location.

In fourth operation 907, the processor of the vehicle control apparatus according to embodiment may deliver insufficiency of the charging remaining capacity or not to a control room.

For example, the control room may handle a situation causing the vehicle or a vehicle including medical equipment and different from the vehicle is able to reach at least one specified location among the locations.

According to an embodiment, a technology in which the vehicle control apparatus supplies power to an electronic device (e.g., medical equipment) included in the vehicle may be referred to as a vehicle-to-load (V2L) technology.

Compared to a battery output of an existing fuel cell vehicle, because an electric vehicle, a hydrogen vehicle, or a hybrid electric vehicle has a high battery output of a battery included in the vehicle, it may stably supply power to medical equipment.

The vehicle control apparatus according to an embodiment may analyze data about a charging remaining capacity (e.g., a state of charge (SOC)) of the battery included in the vehicle and may display information about a drivable distance and equipment operation power on a cluster.

If remaining power necessary to drive to a hospital or an emergency base headquarters or is less than one usage of emergency equipment, depending on an SOC situation, the vehicle control apparatus may automatically activate an alarm and may activate linkage to a paramedic at the headquarters.

Although the SOC of the vehicle is small, the vehicle control apparatus according to embodiment may more prioritize a V2L power output than at least one of a function of an air conditioner system or a function of a part associated with ignition on of the vehicle, or any combination thereof, thus continuously supplying power to medical equipment to ensure that there is no disruption in the use of emergency equipment.

If the charging remaining capacity is less than one usage of the medical equipment, the vehicle control apparatus according to embodiment may sound an alarm and may block a V2L function.

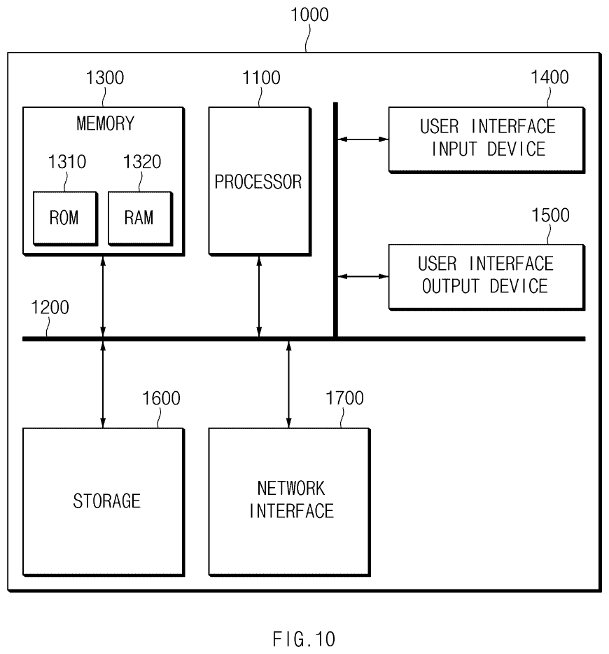

FIG. 10 illustrates a computing system associated with a vehicle control apparatus or a vehicle control method according to an embodiment of the present disclosure.

Referring to FIG. 10, a computing system 1000 may include at least one processor 1010, a memory 1030, a user interface input device 1040, a user interface output device 1050, a storage 1060, and a network interface 1070, which are connected with each other via a bus 1020.

The processor 1010 may be a central processing unit (CPU) or a semiconductor device that processes instructions stored in the memory 1030 and/or the storage 1060. The memory 1030 and the storage 1060 may include various types of volatile or non-volatile storage media. For example, the memory 1030 may include a read only memory (ROM) 1031 and a random access memory (RAM) 1032.

Accordingly, the operations of the method or algorithm described in connection with the embodiments disclosed in the specification may be directly implemented with a hardware module, a software module, or a combination of the hardware module and the software module, which is executed by the processor 1010. The software module may reside on a storage medium (that is, the memory 1030 and/or the storage 1060) such as a RAM, a flash memory, a ROM, an EPROM, an EEPROM, a register, a hard disc, a removable disk, and a CD-ROM.

The exemplary storage medium may be coupled to the processor 1010. The processor 1010 may read out information from the storage medium and may write information in the storage medium. Alternatively, the storage medium may be integrated with the processor 1010. The processor and the storage medium may reside in an application specific integrated circuit (ASIC). The ASIC may reside within a user terminal. In another case, the processor and the storage medium may reside in the user terminal as separate components.

The present technology may supply power from a vehicle to operate medical equipment.

Furthermore, the present technology may operate medical equipment by power supplied from the vehicle at locations which need to use the medical equipment, thus improving user convenience.

Furthermore, the present technology may select a route between the locations which need to use the medical equipment and may monitor a charging remaining capacity of the battery, thus handling a situation causing the vehicle to reach the locations.

Furthermore, the present technology may operate the medical equipment by power supplied by the vehicle, thus providing a patient in a remote place from a medical team with a medical service.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control apparatus, comprising:
a memory storing at least one instruction; and
a processor configured to execute the at least one instruction,
wherein the processor is configured to:
charge a battery used to drive a vehicle by charging or discharging, based on charge power supplied from an external power source;
determine a route based on at least one location included in locations for using medical equipment;
determine an amount of power necessary to drive the vehicle along the route and use the medical equipment; and
provide use of the medical equipment at the at least one location, based on the amount of power and a charging remaining capacity of the battery or provide a user with a notification indicating that it is impossible to use the medical equipment at the at least one location.

2. The vehicle control apparatus of claim 1, wherein the processor is configured to:
deliver insufficiency of the charging remaining capacity or not to a control room which handles a situation causing the vehicle or a vehicle including medical equipment and different from the vehicle to reach at least one specified location among the locations.

3. The vehicle control apparatus of claim 2, wherein the processor is configured to:
provide the user with a notification for guiding the user to select whether to deliver the insufficiency of the charging remaining capacity to the control room or whether to drive the vehicle based on the route although the charging remaining capacity is insufficient, based on that the amount of power is greater than the charging remaining capacity.

4. The vehicle control apparatus of claim 2, wherein the processor is configured to:
monitor the amount of power necessary to drive the vehicle and use the medical equipment and the charging remaining capacity, while driving the vehicle along the route; and
provide the user with a notification indicating that the monitored charging remaining capacity is insufficient, based on that the amount of monitored power is greater than the monitored charging remaining capacity.

5. The vehicle control apparatus of claim 2, wherein the processor is configured to:
deliver the insufficiency of the charging remaining capacity to the control room to drive the vehicle different from the vehicle to the location, based on that the amount of power is greater than the charging remaining capacity.

6. The vehicle control apparatus of claim 1, wherein the processor is configured to:
drive the vehicle along the route, based on that the amount of power is smaller than or equal to the charging remaining capacity of the battery, and supply power to the medical equipment, based on power supplied by the battery at the at least one location; and
provide the user with a notification indicating that the charging remaining capacity is insufficient to supply power to the medical equipment at the at least one location and deliver the insufficiency of the charging remaining capacity to the control room, based on that the amount of power is greater than the charging remaining capacity.

7. The vehicle control apparatus of claim 1, wherein the processor is configured to:
provide the user with information about that the charging remaining capacity is insufficient for the vehicle to reach any one location among the at least one location or information about that the charging remaining capacity is insufficient to use the medical equipment after the vehicle reaches the any one location by mean of the notification, if the amount of power is greater than the charging remaining capacity.

8. The vehicle control apparatus of claim 1, wherein the processor is configured to:
receive at least one other location included in the locations which are not the medical facilities, but need to use the medical equipment and is different from the at least one location from the control room, while driving the vehicle along the route;
determine a route different from the route based on the at least one other location;
determine an amount of new power necessary to drive the vehicle along the different route and use the medical equipment;
determine a charging remaining capacity of the battery at a time point when the amount of new power is determined;
drive the vehicle along the different route, based on that the amount of new power is smaller than or equal to the charging remaining capacity at the time point, and supply power to the medical equipment, based on power supplied by the battery at the at least one location; and
provide the user with a notification indicating that the charging remaining capacity at the time point is insufficient to supply power to the medical equipment at the at least one location, based on that the amount of new power is greater than the charging remaining capacity at the time point.

9. The vehicle control apparatus of claim 1, wherein the processor is configured to:
limit at least one of a function of an air conditioner system or a function of a part associated with ignition on of the vehicle, or any combination thereof, if the charging remaining capacity is less than a first threshold charging remaining capacity and is greater than or equal to a second threshold charging remaining capacity capable of using the medical equipment a specified number of times and smaller than the first threshold charging remaining capacity.

10. The vehicle control apparatus of claim 1, wherein the processor is configured to:
limit at least one of a function of an air conditioner system or a function of a part associated with ignition on of the vehicle, or any combination thereof, if an expected charging remaining capacity of the battery after the vehicle reaches the at least one location is less than a first threshold charging remaining capacity and is greater than or equal to a second threshold charging remaining capacity capable of using the medical equipment a specified number of times and smaller than the first threshold charging remaining capacity, based on an amount of power necessary to drive the vehicle along the route.

11. The vehicle control apparatus of claim 10, wherein the processor is configured to:
deliver insufficiency of the expected charging remaining capacity to a control room, if the expected charging remaining capacity is less than the second threshold charging remaining capacity.

12. The vehicle control apparatus of claim 1, wherein the processor is configured to:
provide the user with a screen for guiding the user via a distance the vehicle is able to reach by power of the charging remaining capacity depending on the number of the at least one location, based on at least one of the charging remaining capacity, an amount of power necessary to drive the vehicle along the route, or an amount of power necessary to use the medical equipment, or any combination thereof.

13. A vehicle control method, comprising:
charging a battery used to drive a vehicle by charging or discharging, based on charge power supplied from an external power source;
determining a route based on at least one location included in locations for using medical equipment;
determining an amount of power necessary to drive the vehicle along the route and use the medical equipment; and
providing use of the medical equipment at the at least one location, based on the amount of power and a charging remaining capacity of the battery or providing a user with a notification indicating that it is impossible to use the medical equipment at the at least one location.

14. The vehicle control method of claim 13, further comprising:
delivering insufficiency of the charging remaining capacity or not to a control room which handles a situation causing the vehicle or a vehicle including medical equipment and different from the vehicle to reach at least one specified location among the locations.

15. The vehicle control method of claim 13, wherein the providing of the use of the medical equipment at the at least one location, based on the amount of power and the charging remaining capacity of the battery or the providing of the notification indicating that it is impossible to use the medical equipment at the at least one location to the user includes:
driving the vehicle along the route, based on that the amount of power is smaller than or equal to the charging remaining capacity of the battery, and supplying power to the medical equipment, based on power supplied by the battery at the at least one location; and
providing the user with a notification indicating that the charging remaining capacity is insufficient to supply power to the medical equipment at the at least one location, based on that the amount of power is greater than the charging remaining capacity, and
wherein the delivering of the insufficiency of the charging remaining capacity or not to the control room which handles the situation causing the vehicle or the vehicle including the medical equipment and different from the vehicle to reach the at least one specified location among the locations includes:
delivering the insufficiency of the charging remaining capacity to the control room, based on that the amount of power is greater than the charging remaining capacity.

16. The vehicle control method of claim 13, wherein the providing of the use of the medical equipment at the at least one location, based on the amount of power and the charging remaining capacity of the battery or the providing of the notification indicating that it is impossible to use the medical equipment at the at least one location to the user includes:
providing the user with information about that the charging remaining capacity is insufficient for the vehicle to reach any one location among the at least one location or information about that the charging remaining capacity is insufficient to use the medical equipment after the vehicle reaches the any one location by mean of the notification, if the amount of power is greater than the charging remaining capacity.

17. The vehicle control method of claim 13, further comprising:
receiving at least one other location included in the locations which are not the medical facilities, but need to use the medical equipment and is different from the at least one location from the control room, while driving the vehicle along the route;
determining a route different from the route based on the at least one other location;
determining an amount of new power necessary to drive the vehicle along the different route and use the medical equipment;
determining a charging remaining capacity of the battery at a time point when the amount of new power is determined;
driving the vehicle along the different route, based on that the amount of new power is smaller than or equal to the charging remaining capacity at the time point, and supplying power to the medical equipment, based on power supplied by the battery at the at least one location;
providing the user with a notification indicating that the charging remaining capacity at the time point is insufficient to supply power to the medical equipment at the at least one location, based on that the amount of new power is greater than the charging remaining capacity at the time point; and
delivering insufficiency of the charging remaining capacity at the time point to the control room.

18. The vehicle control method of claim 13, further comprising:
limiting at least one of a function of an air conditioner system or a function of a part associated with ignition on of the vehicle, or any combination thereof, if the charging remaining capacity is less than a first threshold charging remaining capacity and is greater than or equal to a second threshold charging remaining capacity capable of using the medical equipment a specified number of times and smaller than the first threshold charging remaining capacity.

19. The vehicle control method of claim 13, further comprising:
limiting at least one of a function of an air conditioner system or a function of a part associated with ignition on of the vehicle, or any combination thereof, if an expected charging remaining capacity of the battery after the vehicle reaches the at least one location is less than a first threshold charging remaining capacity and is greater than or equal to a second threshold charging remaining capacity capable of using the medical equipment a specified number of times and smaller than the first threshold charging remaining capacity, based on an amount of power necessary to drive the vehicle along the route.

20. The vehicle control method of claim 13, further comprising:
providing the user with a screen for guiding the user via a distance the vehicle is able to reach by means of power of the charging remaining capacity depending on the number of the at least one location, based on at least one of the charging remaining capacity, an amount of power necessary to drive the vehicle along the route, or an amount of power necessary to use the medical equipment, or any combination thereof.
